(19) United States
(12) Patent Application Publication
(10) Pub. No.: US 2015/0189583 A1
(43) Pub. Date: Jul. 2, 2015

(54) RADIO COMMUNICATION SYSTEM, BASE STATION, AND CELL SELECTION CONTROL METHOD

(71) Applicant: Hitachi, Ltd., Tokyo (JP)

(72) Inventors: Satoshi Tamaki, Tokyo (JP); Tomonori Yamamoto, Tokyo (JP); Hitoshi Ishida, Tokyo (JP); Eriko Takeda, Tokyo (JP); Go Ono, Tokyo (JP)

(21) Appl. No.: 14/122,784

(22) PCT Filed: Nov. 29, 2012
(86) PCT No.: PCT/JP2012/080968

§ 371 Date: Nov. 27, 2013

(51) Int. Cl. H04W 48/20

(52) U.S. Cl. CPC H04W 48/20

(57) ABSTRACT

The present invention provides a method of controlling the selection of a cell in a radio communication system for increasing the capacity of the system by effectively utilizing a small cell base station and a base station apparatus for realizing it. At least one base station of a macrocell base station and a small cell base station is provided with plural antennas, and the base station selects a cell and adjusts a criterion for reselection by generating processing gain using the plural antennas by signal processing and performing a cell selection bias correcting process using the processing gain using the plural antennas.

### FIELD OF THE INVENTION

The present invention relates to a radio communication system, especially relates to technique that controls the selection of a cell in a cellular radio communication system.

### BACKGROUND OF THE INVENTION

According to the band widening of radio communication, a multicarrier communication mode of dividing transmit information into plural frequency bands called a subcarrier to communicate is used. OFDM (Orthogonal Frequency Division Multiplexing) in the multicarrier communication mode is adopted in various systems because a guard band between subcarriers is made unnecessary by utilizing the orthogonality of a signal, enhancing resistance to a delayed wave by narrowing bandwidth per subcarrier, and the high frequency efficiency can be realized. In addition, OFDMA (Orthogonal Frequency Division Multiple Access) for multiple access by dividing radio resources in the OFDM per unit called a resource block having fixed time length with one or plural subcarriers is adopted in a radio communication system called WiMAX (Worldwide Interoperability of Microwave Access) and LTE (Long Term Evolution).

In addition, in the radio communication system, a user terminal can communicate by radio in a broad range by installing plural base stations which are hereinafter called a macrocell base station, which require great transmit power and a cover area per which ranges from a few hundred meters to a few kilometers for example. However, since a radio wave used for radio communication is obstructed or attenuated by a building and the like, an indoor location where a radio wave from a macrocell base station weakens occurs. Moreover, since the number of user terminals in an area increases as the cover area of a macrocell base station becomes wider, available radio resources to each user terminal decreases.

Therefore, a base station which is hereinafter called a small cell base station, which requires only small transmit power and a cover area per which is small is sometimes installed. A user terminal can also perform stable communication at a location where a radio wave from a macrocell base station weakens by installing the small cell base station, the number of user terminals per base station is reduced by assigning the user terminal the small cell base station, and available radio resources to each user terminal can be increased.

Generally, a user terminal selects a cell of which the received power is the strongest. However, it is desirable that many user terminals are assigned to a small cell base station to increase the traffic of the whole system. Therefore, a method and effect in which a user terminal selects a small cell base station even if its received power is not the strongest are described in 3GPP TSG-RAN WG1 #59 R1-010701, “Importance of Serving Cell Selection in Heterogeneous Networks”, Qualcomm Incorporated, January 2010.

### SUMMARY OF THE INVENTION

For example, in the abovementioned document, it is described that the user terminal can acquire an advantage of the enhancement of throughput by selecting the small cell base station even if the received power is not the strongest. However, for example, as to upstream communication, since the communication of a terminal assigned a small cell base station functions as interference with the communication of a terminal assigned a macrocell base station and therefore the transmission speed of the terminal assigned the macrocell base station may be deteriorated, it is not necessarily related to the increase of the capacity of the whole system to assign multiple terminals to the small cell base station.

An object of the present invention is to settle the abovementioned problem and to provide a radio communication system, a base station and a cell selection control method respectively for increasing the capacity of the system by effectively utilizing a small cell base station.

To achieve the object, the present invention is based upon a radio communication system in which a terminal and a base station communicate by radio and provides the radio communication system where the base station is provided with plural antennas, measures processing gain using the plural antennas and adjusts a range in which the terminal is connected to a corresponding base station according to the processing gain.

In addition, to achieve the object, the present invention is based upon the base station of the radio communication system and provides the base station provided with plural antennas, a communication unit that communicates with a user terminal by radio, and a processor that measures processing gain using the plural antennas and adjusts a range in which the user terminal is connected to a corresponding base station according to the processing gain.

Further, to achieve the object, the present invention is based upon a cell selection control method of a base station and provides the cell selection control method in which the base station is provided with plural antennas, measures processing gain using the plural antennas, and adjusts a range where a terminal is connected to a corresponding base station according to the measured processing gain.

According to the present invention, a small cell base station is effectively utilized and the capacity of the radio communication system can be increased.

### BRIEF DESCRIPTION OF THE DRAWINGS

FIG. 1 shows one example of the configuration of a radio communication system of each embodiment;

FIG. 2 shows a flow of processing for correcting a cell selection bias value in the first embodiment;

FIG. 3 shows one example of interference elimination information in the first embodiment;

FIG. 4 shows one example of a flow of cell selection bias determining processing in the first embodiment;

FIG. 5 shows one example of the determination of cell selection bias in the first embodiment;

FIG. 6 shows one example of a flow of processing until the execution of handover in the first embodiment;

FIG. 7 shows a flow of a process for correcting a cell selection bias value in a second embodiment;

FIG. 8 shows one example of the configuration of a base station apparatus mainly including DSP and CPU in each embodiment; and

FIG. 9 is one example of a block diagram showing a flow of received signal processing including processing gain output processing.

### DETAILED DESCRIPTION OF THE PREFERRED EMBODIMENTS

Referring to the drawings, embodiments of the present invention will be described below.

In the following description of the embodiments, a pilot signal denotes a signal having a fixed or semifixed pattern used as a reference signal in relation to amplitude and a phase when a received signal is demodulated or as a reference signal for estimating received power or propagation path information, and is also called a reference signal. In addition, a pilot signal used as a reference signal in demodulation and a pilot signal used as a reference signal for estimating received power or propagation path information may also be the same and may also be separate signals. In addition, a pilot signal may also be shared among plural user terminals in a cell and may also be individually used every user terminal.

Further, in the following embodiments, a flow of a sequence and processing may be described in specific order, except a case that there is such dependence upon order that a result of certain processing is used in the next processing, the order of processing may also be changed and processing may also be made in parallel. Further, in a case that a result of the execution of anterior processing is used for posterior processing, respective processing is also asynchronously executed and a result of the execution of the latest anterior processing at the time of execution may also be used for the posterior processing.

Furthermore, in the following embodiments, a base station the transmit power of which is relatively great and which communicates with terminals in a wide range is called a macrocell base station, a base station the transmit power of which is small and which communicates with terminals in a small range is called a small cell base station, and when the macrocell base station and the small cell base station are not required to be discriminated, they are merely called a base station.

### First Embodiment

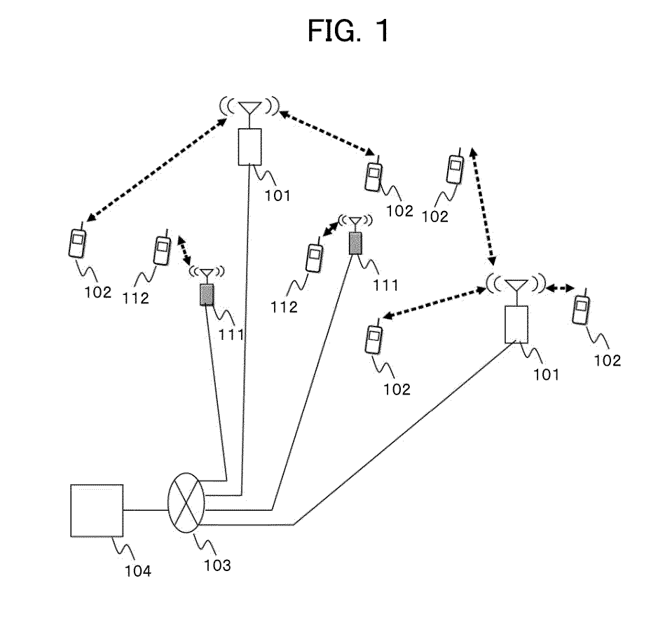

FIG. 1 shows one example of the configuration of a radio communication system related to all embodiments including a first embodiment. The radio communication system having this configuration is provided with plural macrocell base stations 101, plural small cell base stations 111, plural user terminals 102, 112, a network 103 connected to the plural base stations, and a core network 104 connected to the base stations via the network. In the following description, a signal and communication from the macrocell base station 101 or the small cell base station 111 to the user terminal 102 or 112 are called are called a downlink signal and downlink communication. Conversely, a signal and communication from the user terminal 102 or 112 to the macrocell base station 101 or the small cell base station 111 are called an uplink signal and uplink communication.

The macrocell base station 101 is connected to the core network 104 via the network 103. The macrocell base station 101 transmits a downlink signal toward the user terminal 102 and receives an uplink signal transmitted by the user terminal 102. The small cell base station 111 is connected to the core network 104 via the network 103 like the macrocell base station 101, transmits a downlink signal toward the user terminal 112, and receives an uplink signal transmitted by the user terminal 112.

The network 103 to which the macrocell base station 101 is connected and the network 103 to which the small cell base station 111 is connected may also be the same network and may also be separate networks connected via a gateway. The core network 104 is provided with a function for mobility management and a gateway function with another network.

It is selected based upon the quality of the reception of a downlink signal or an uplink signal and propagation loss whether the user terminal 102 or 112 communicates with the macrocell base station 101 or the small cell base station 111, and when propagational environment varies because of the movement of the user terminal and the like, the base station to be communicated is selected again via the core network 104. In FIG. 1, a range in which the small cell base station 111 communicates with the user terminal is narrower than a range in which the macrocell base station 101 communicates with the user terminal. In addition, regardless of whether the macrocell base station or the small cell base station, the range in which the base station communicates may also be included between the plural base stations and a part of the range may also be overlapped.

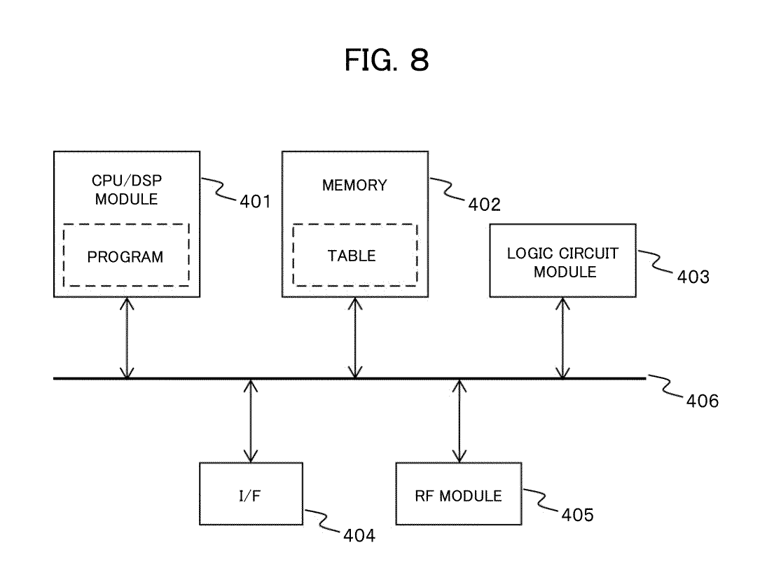

In addition, at least one base station of the macrocell base station 101 and the small cell base station 111 is provided with plural antennas, and the selection of a cell and the adjustment of a criterion for reselection are performed by processing for correcting a cell selection bias value to be applied to the intensity in the reception of a reference signal to select the cell using gain acquired by signal processing using the plural antennas by the corresponding base station. As for the detailed configuration of the base station in the embodiment, one example will be described using FIG. 8 below.

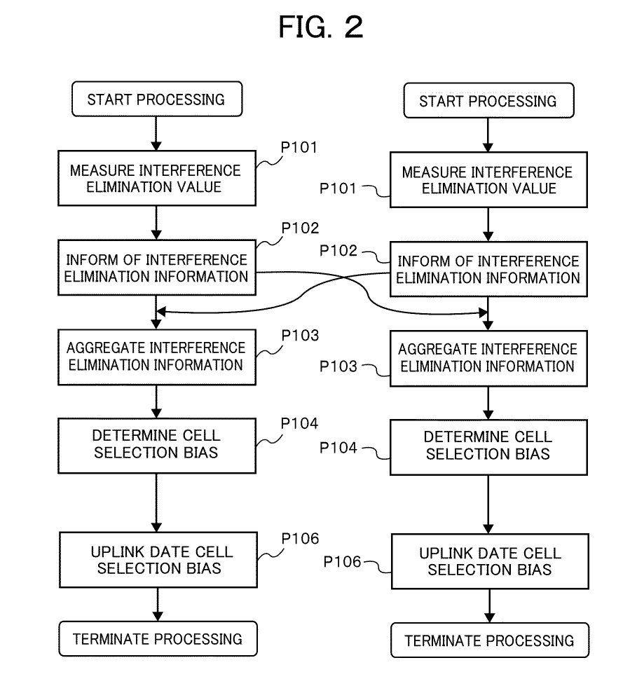

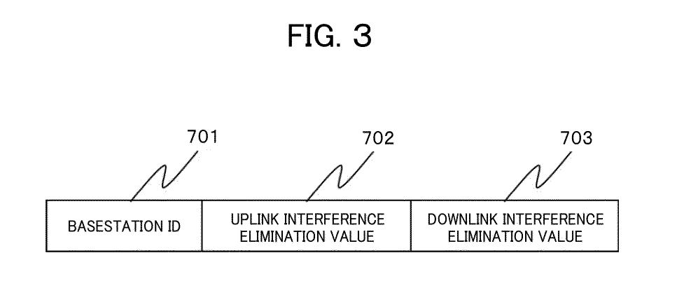

FIG. 2 shows a flow of the processing for correcting the cell selection bias value in the first embodiment. FIG. 3 shows one example of interference elimination information in the first embodiment. In a cell selection bias correcting process in this embodiment, each base station executes similar processing, mutually notifies of information, and informed results are aggregated. In FIG. 2, the processing by only two of these base stations is shown. However, the processing is not limited to the two base stations. Since each base station executes the similar processing, only a flow of the processing related to the single base station will be described to be simple in the following description. The cell selection bias correcting process is executed by a processor described later in the base station.

As shown in FIG. 2, in the cell selection bias correcting process, processing for measuring an interference elimination value, the generation of interference elimination information in other words is first performed in a step P101. In the interference elimination value measuring step P101, the interference elimination information of the base station is generated based upon the quality of a signal received by the base station and the quality of a signal received by the terminal and reported from the terminal to the base station. Interference elimination information in this embodiment is a value shown in FIG. 3 for example and is configured by the combination of base station ID 701, an uplink interference elimination value 702 and a downlink interference elimination value 703. Only one of the uplink interference elimination value 702 and the downlink interference elimination value 703 may be used.

The uplink interference elimination value 702 is acquired from processing gain by using the plural antennas. When an uplink signal from the individual user terminal is received in a process of received signal processing in the base station for example, the processing gain by using the plural antennas can be calculated based upon the received power of a signal received by the single antenna for example or the received power to interference and noise power ratio, and received power after signals received by the plural antennas are synthesized or the received power to interference and noise power ratio respectively. Average processing gain is acquired by averaging processing gain for an uplink signal from the individual user terminal among processing gain for plural user terminals and this is regarded as an uplink interference elimination value of the base station.

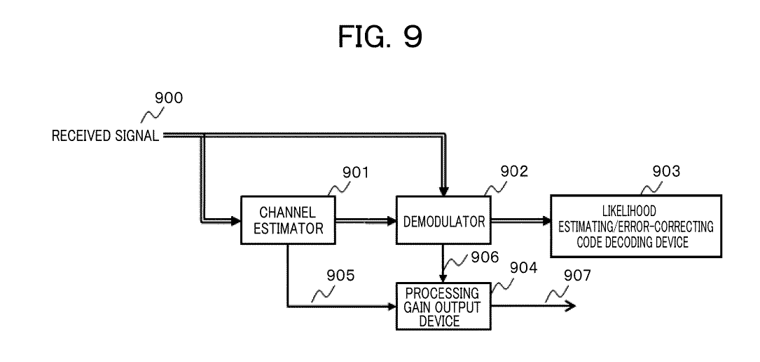

FIG. 9 is a functional block diagram showing one example of a flow of received signal processing including processing for outputting processing gain in the base station provided with the plural antennas in this embodiment. These functional blocks can be realized by the processor described later in the base station. In the example shown in FIG. 9, a received signal 900 received via a radio frequency (RF) module which is not shown and which is a radio communication device from the plural antennas is passed to a channel estimator 901 and a demodulator 902 respectively realized by the processor described later in the base station.

The channel estimator 901 estimates channel information showing the variation of a signal in a propagation channel every transmitting antenna, every receiving antenna, every frequency and every time utilizing the abovementioned pilot signal which is a signal of a well-known pattern included in the received signal. The channel estimator 901 also notifies the demodulator 902 of the estimated channel information. Further, the channel estimator 901 calculates received power to interference and noise power ratio 905 based upon the estimated channel information and notifies a processing gain output device 904.

The demodulator 902 executes processing for demodulating the received signal using the channel information notified from the channel estimator 901. The processing for demodulating the received signal is equalizing processing using a MMSE (minimum mean square error) method for example or is orthogonalizing processing using a result of the QR decomposition of the channel information for example. A result of the processing for demodulation in the demodulator 902 is transmitted to a likelihood estimating/error-correcting code decoding device 903. The likelihood estimating/error-correcting code decoding device 903 decodes an error-correcting code after the device estimates likelihood. The demodulator 902 also estimates each received signal after demodulation to interference and noise power ratio 906 using the result of the processing for demodulation and notifies the processing gain output device 904 of a result of estimation.

The processing gain output device 904 outputs the ratio of the received power to interference and the noise power ratio 905 respectively notified from the channel estimator 901 and the received power after demodulation to interference and the noise power ratio 906 respectively notified from the demodulator 902 as processing gain 907.

For the downlink interference elimination value 703 shown in FIG. 3, the uplink interference elimination value 702 for example can be used as it is. Or when there is no difference in a frequency or when the difference in a frequency is small, the uplink interference elimination value 702 is used for the downlink interference elimination value 703 using the difference in a frequency between the uplink signal and the downlink signal, and when the difference in a frequency is great, a value smaller than the uplink interference elimination value 702 may also be used for the downlink interference elimination value 703.

For the downlink interference elimination value 703, a value when the user terminal measures the difference between the quality of the reception in the user terminal of a signal which the base station individually transmits to the user terminal using the plural antennas and the quality of the reception in the user terminal of a signal which the base station broadcasts in the cell, and reports the value of the measured difference to the base station, may also be used. In this case, the higher the quality of the reception in the user terminal of the signal individually transmitted to the user terminal is, the larger value the downlink interference elimination value 703 becomes.

Next, as shown in FIG. 2 again, in interference elimination information notifying processing in a step P102, the base station mutually notifies its peripheral base stations of interference elimination information generated in the interference elimination value measuring processing P101 and receives the notified interference elimination information. In this case, the peripheral base station means a base station of a cell geographically adjacent for example. In addition, in the case of the small cell base station, for its peripheral base station, one or plural macrocell base stations the communication range of which is overlapped with that of the corresponding base station are selected. In the case of the macrocell base station, for its peripheral base station, one or plural small cell base stations the communication range of which is overlapped with that of the corresponding base station are selected. Or in the case of the macrocell base station, for its peripheral base station, a macrocell base station the communication range of which is overlapped with that of the corresponding base station or the communication range of which touches that of the corresponding base station is selected in addition to one or plural small cell base stations the communication range of which is overlapped with that of the corresponding base station.

Next, in interference elimination information aggregating processing in a step P103 shown in FIG. 2, the interference elimination information of the corresponding base station generated in the interference elimination value measuring processing P101 and the interference elimination information of the peripheral base stations notified in the interference elimination information notifying processing P102 are stored. When interference elimination information is newly notified from the base station the interference elimination information of which is already stored, the stored information is updated to be the newly notified information. Or when interference elimination information is newly notified from the base station the interference elimination information of which is already stored, the uplink interference elimination value and the downlink interference elimination value in the stored interference elimination information, an uplink interference elimination value and a downlink interference elimination value in the newly notified interference elimination information are averaged using a forgetting factor.

Next, in cell selection bias determining processing in a step P104 shown in FIG. 2, a cell selection bias value is determined based upon the interference elimination information of the corresponding base station and the peripheral base stations stored in the interference elimination information aggregating processing P103. In the cell selection bias determining processing P104, the cell selection bias value is determined so that the larger an uplink interference elimination value of the corresponding base station is than an uplink interference elimination value of the peripheral base station, the smaller the cell selection bias value becomes and so that the larger a downlink interference elimination value of the corresponding base station is than a downlink interference elimination value of the peripheral base station, the larger the cell selection bias value becomes. When an uplink interference elimination value or a downlink interference elimination value of the corresponding base station or the peripheral base station is not acquired, the corresponding value is handled as zero.

Next, in cell selection bias updating processing in a step P106 shown in FIG. 2, a cell selection bias value used in the base station is updated to be the cell selection bias value determined in the cell selection bias determining processing P104. In the base station, the cell selection bias value is used for calculating a cell individual offset value reported as a part of measurement information in a cell for example and is used for one of a judgment condition in determining the handover of each terminal. The cell individual offset value is calculated so that the cell individual offset value has positive correlation with the cell selection bias value. In addition, in determining handover, a judgment condition is corrected so that handover with the base station having a large cell selection bias value is facilitated.

The abovementioned process is not required to be performed in the plural base stations in order in synchronization. For example, the interference elimination information aggregating processing P103 is not executed using the termination of the interference elimination information notifying processing P102 for a trigger but may also be executed using the information of interference elimination information from the peripheral base station for a trigger. In addition, the cell selection bias determining processing P104 is not executed using the termination of the interference elimination information aggregating processing P103 for a trigger but may also be periodically executed at a fixed interval.

Because of the process for correcting cell selection bias of this embodiment mentioned above, the higher the capability of downlink interference elimination of the corresponding base station is or the higher the capability of uplink interference elimination of the peripheral base station is, the more easily the user terminal can be connected to the corresponding base station by the abovementioned cell selection bias correcting process in this embodiment, and as a range of the cell of the corresponding base station is extended, the dispersion of a load between cells and the increase of system throughput are enabled, keeping an effect by interference between the cells low. Further, in environment in which a macrocell and a small cell exist together, the small cell can be effectively utilized.

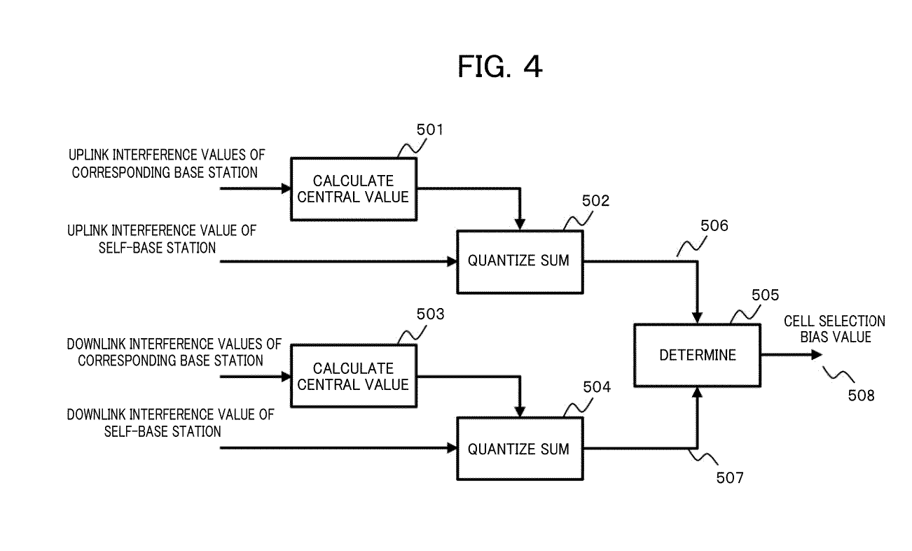

FIG. 4 shows one example of functional blocks in a flow of the cell selection bias determining processing P104 in the abovementioned cell selection bias correcting process shown in FIG. 2 in this embodiment. As shown in FIG. 4, in a step 501 in the cell selection bias determining processing P104, a central value of uplink interference values of the peripheral base stations is calculated based upon the uplink interference values of the peripheral base stations by selecting averaging processing and a median for example. In a step 502, a quantized uplink interference elimination value 506 is calculated based upon the central value of the uplink interference values of the peripheral base stations acquired in the step 501 and an uplink interference value of the corresponding base station. In this case, the quantized uplink interference elimination value 506 is selected so that the larger the central value of the uplink interference values of the peripheral base stations is than the uplink interference value of the corresponding base station, the larger the quantized uplink interference elimination value becomes and so that the smaller the central value of the uplink interference values of the peripheral base stations is than the uplink interference value of the corresponding base station, the smaller the quantized uplink interference elimination value becomes.

In a step 503 in the cell selection bias determining processing, a central value of downlink interference values of the peripheral base stations is calculated based upon the downlink interference values of the peripheral base stations by selecting averaging processing and a median for example. In a step 504, a quantized downlink interference elimination value 507 is calculated based upon the central value of the downlink interference values of the peripheral base stations acquired in the step 503 and a downlink interference value of the corresponding base station. In this case, the quantized downlink interference elimination value 507 is selected so that the larger the central value of the downlink interference values of the peripheral base stations is than the downlink interference value of the corresponding base station, the larger the quantized downlink interference elimination value becomes and so that the smaller the central value of the downlink interference values of the peripheral base stations is than the downlink interference value of the corresponding base station, the smaller the quantized downlink interference elimination value becomes.

Next, in a step 505 in the cell selection bias determining processing, a cell selection bias value 508 is determined based upon the quantized uplink interference elimination value acquired in the step 502 and the quantized downlink interference elimination value acquired in the step 504.

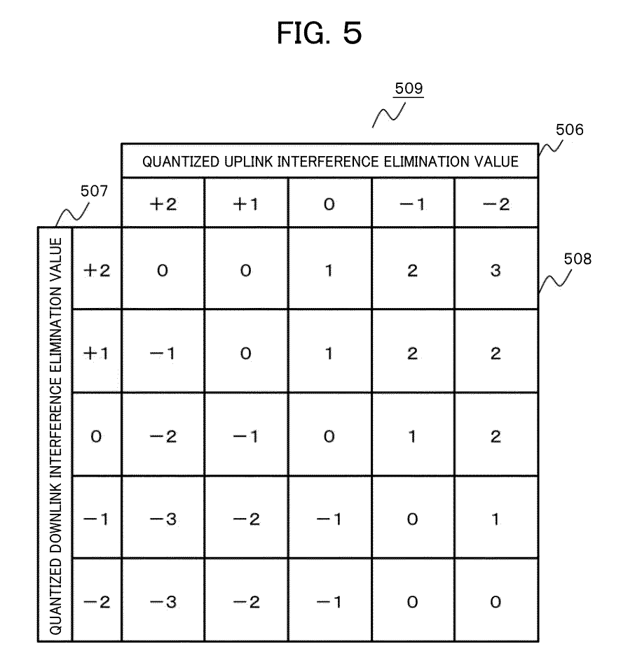

FIG. 5 is an explanatory drawing for explaining one example of the determination of the cell selection bias value 508 in this embodiment. A bias value table 509 showing the example of the determination in FIG. 5 shows relation with the cell selection bias value 508 when five values −2, −1, 0, 1, 2 in a direction of a matrix of the quantized uplink interference elimination value 506 and the quantized downlink interference elimination value 507 are used, and the larger the quantized uplink interference elimination value 506 on the line side is, the smaller the cell selection bias value 508 becomes, and the larger the quantized downlink interference elimination value 507 on the column side is, the larger the cell selection bias value 508 becomes.

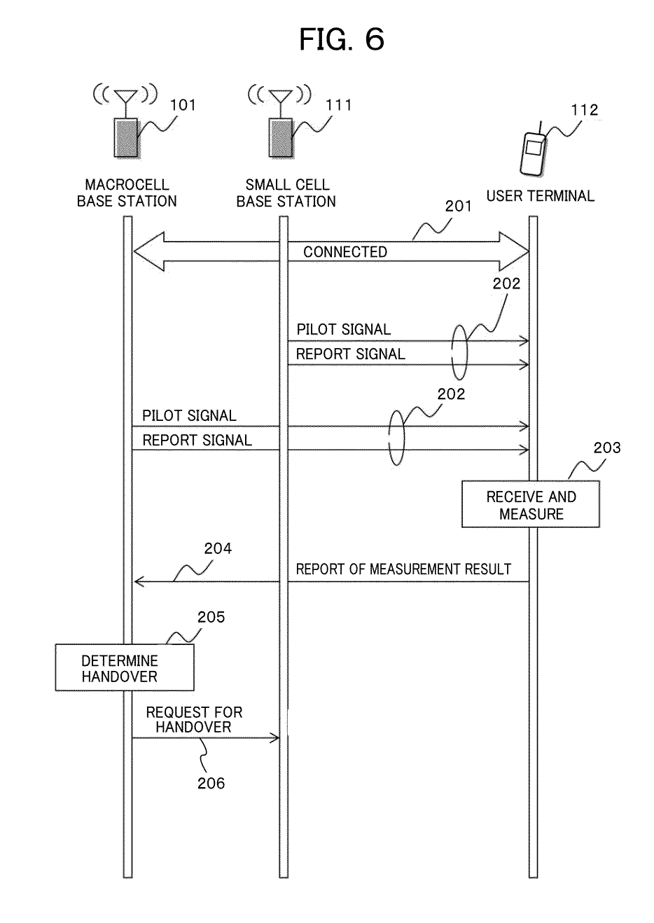

FIG. 6 shows one example of a flow of processing until the execution of handover where the base station to which the user terminal is connected is changed during communication in the radio communication system in this embodiment. FIG. 6 shows a sequence until the user terminal 112 connected to the macrocell base station 101 is handed to the small cell base station 111 for example.

In an initial state of the sequence shown in FIG. 6, the user terminal 112 is connected to the macrocell base station 101. In addition, the macrocell base station 101 and the small cell base station 111 continuously or periodically transmit a pilot signal and a report signal 202 in a range of each cell. Report information includes a cell individual offset value transmitted from the base station side to the user terminal and the cell individual offset value transmitted to the user terminal by the cell selection bias correcting process in the base station as described above is corrected so that the cell individual offset value is low in the base station having high ability to eliminate uplink interference and so that the cell individual offset value is high in the base station having high ability to eliminate downlink interference.

The user terminal 112 measures received power based upon a pilot signal received from the base station in receiving/measuring processing 203 and reports a measurement result 204 to the connected macrocell base station 101 when the measurement result meets a predetermined condition such as when signal received power from the small cell base station 111 is higher than signal received power from the macrocell base station 101 after correction according to information included in the report signal.

In the receiving/measuring processing 203 in the user terminal 112, when the received power is compared, a cell individual offset value included in a report signal from the base station is corrected in addition to the received power. Hereby, a received signal from the base station having a high cell individual offset value is regarded as having great signal power. For example, even if a report of a measurement result is determined when signal received power from another base station is more than signal received power from the connected base station, the report of the measurement result is difficult because of the comparison after the addition of the cell individual offset value when the cell individual offset value of the connected base station is relatively large, and when the cell individual offset value of the connected base station is relatively small, the report of the measurement result becomes simple.

The macrocell base station 101 receives the report of the measurement result and determines whether handover to the small cell base station 111 is to be executed or not in handover determining processing 205. For the determination of handover, a degree of congestion of the handover source base station and the handover destination base station, the difference in received power between the reported measurement results and the like are used, and it is judged that the greater the received power from the handover destination base station of the reported received power is, the more easily the handover is executed. At this time, the judgment of handover is corrected so that the larger a cell selection bias value of the handover destination base station is, the more easily the handover is executed and so that the larger a cell selection bias value of the handover source base station, the more difficult it is to execute the handover.

The handover from the macrocell base station 101 to the small cell base station 111 is described above for an example. However, handover from the macrocell base station 101 to another macrocell base station 101, handover from the small cell base station 111 to the macrocell base station 101, and handover from the small cell base station 111 to another small cell base station 111 are also similar.

Although the handover is described above, cell reselection processing in non-communication of the user terminal is also similar. In addition, not handover of a type that completely switches to a connected cell but a case that transmit-receive base stations are switched in only a part of channel is also similar.

According to the abovementioned first embodiment, the small cell base station can be effectively utilized and the capacity of the radio communication system can be increased.

### Second Embodiment

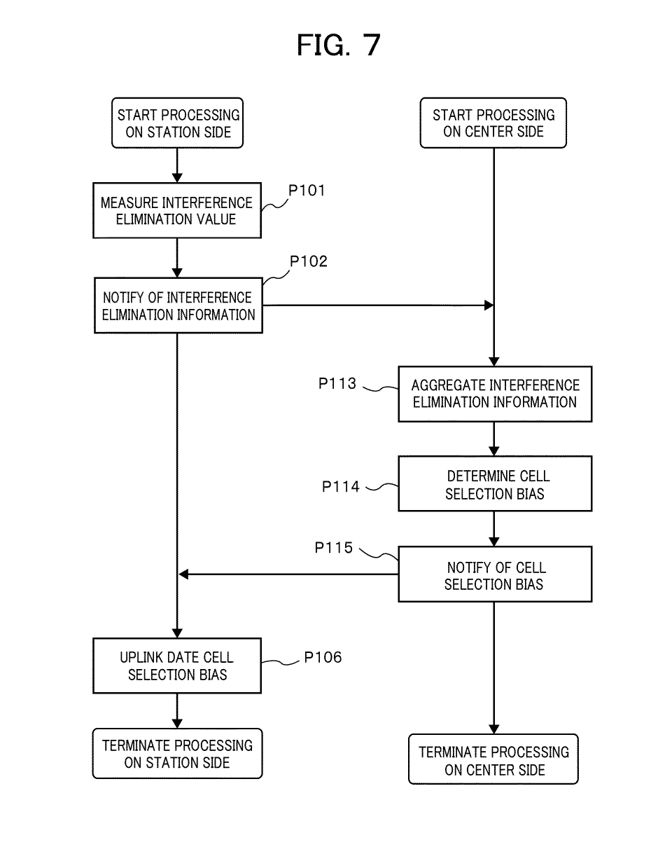

Next, a second embodiment in which cell selection bias values of plural base stations are collectively determined in a center will be described referring to FIG. 7. FIG. 7 shows a flow of a cell selection bias correcting process in the second embodiment. In the cell selection bias correcting process in the first embodiment, cell selection bias is determined in each base station. However, in the cell selection bias correcting process in this embodiment, cell selection bias values of plural base stations are collectively determined in the center. The cell selection bias correcting process is also executed by a processor described above in a base station.

In FIG. 7, only one base station of the plural base stations is shown. In the following description, the one base station is described, but the similar processing is respectively executed in the plural base stations. The center in this embodiment may also exist in the core network 104 as shown in FIG. 1 as an independent center, and a specific base station may also be provided with a function described later as a center in addition to a function as a base station.

Interference elimination value measuring processing P101 shown in FIG. 7 in the second embodiment is similar to the interference elimination value measuring processing P101 in the first embodiment. In addition, interference elimination information notifying processing P102 shown in FIG. 7 is similar to the interference elimination information notifying processing P102 in the first embodiment except that a destination notified of interference elimination information is not the peripheral base station but the center.

In interference elimination information aggregating processing P113, interference elimination information notified in the interference elimination information notifying processing P102 from each base station is stored. When interference elimination information is newly notified from a base station the interference elimination information of which is already stored, the stored information is updated to be the newly notified information. Or when interference elimination information is newly notified from a base station the interference elimination information of which is already stored, an uplink interference elimination value and a downlink interference elimination value respectively in the stored interference elimination information, an uplink interference elimination value and a downlink interference elimination value respectively in the newly notified interference elimination information are averaged using a forgetting factor.

Next, in cell selection bias determining processing P114 shown in FIG. 7, a cell selection bias value of each base station is determined based upon the interference elimination information of each base station stored in the interference elimination information aggregating processing P113. When the cell selection bias value of each base station is determined in the cell selection bias determining processing P114, interference elimination information of a peripheral base station of the corresponding base station is used in addition to the interference elimination information of the corresponding base station. In this case, the peripheral base station means a base station having a geographically adjacent cell for example. In the case of a small cell base station, one or plural macrocell base stations overlapped with the corresponding base station in a communication range are selected as a peripheral base station. In addition, in the case of a macrocell base station, one or plural small cell base stations overlapped with the corresponding base station in a communication range are selected as a peripheral base station. Or in the case of a macrocell base station, a macrocell base station overlapped with the corresponding base station in a communication range or touched to the corresponding base station in the communication range is selected in addition to one or plural small cell base stations overlapped with the corresponding base station in a communication range as a peripheral base station.

In the cell selection bias determining processing P114 shown in FIG. 7, a cell selection bias value is determined so that the larger an uplink interference elimination value of the corresponding base station is than an uplink interference elimination value of its peripheral base station, the smaller the cell selection bias value becomes and so that the larger a downlink interference elimination value of the corresponding base station is than a downlink interference elimination value of the peripheral base station, the larger the cell selection bias value becomes. When the uplink interference elimination value or the downlink interference elimination value of the corresponding base station or its peripheral base station is not acquired, the corresponding value is handled as zero.

In cell selection bias notifying processing P115 shown in FIG. 7, the corresponding base station is notified of the cell selection bias value of each base station determined by the cell selection bias determining processing P114.

Cell selection bias updating processing P106 shown in FIG. 7 is similar to the cell selection bias updating processing P106 in the first embodiment except that a value determined in a base station as a cell selection bias value is not used but a value notified from the center is used.

The abovementioned processing is not required to be executed in order in synchronization in plural base stations. For example, the cell selection bias determining processing P114 is not executed using the termination of the interference elimination information aggregating processing P113 for a trigger but may also be regularly executed at a fixed interval.

Also in this embodiment as in the first embodiment, by the cell selection bias correcting process in the second embodiment, the higher the ability of downlink interference elimination of the corresponding base station is or the higher the ability of uplink interference elimination of its peripheral base station is, the more easily a user terminal can be connected to the corresponding base station, and a load between cells is dispersed while keeping an effect by interference between the cells low because a range of the cell of the corresponding base station is extended, and the throughput of the system can be increased. Further, in environment in which a macrocell and a microcell exist together, the microcell can be effectively utilized.

FIG. 8 shows an apparatus in the base station in each embodiment. In FIG. 8, one example of the configuration of the base station mainly configured by a processor including a digital signal processor (DSP), a central processing unit (CPU) and a logic circuit is shown. The base station shown in FIG. 8 is provided with a CPU/DSP module 401 respectively configuring the processor, a memory 402 which is a storage, a logic circuit module 403 configuring the processor, a network interface (I/F) 404, and an RF module 405 which is connected to one or plural antennas and which is a radio communication device, and they are connected via a bus 406.

Each processing shown in FIGS. 2 and 7 is executed using one or both of a program in the CPU/DSP module 401 and an arithmetic circuit in the logic circuit module 403 respectively configuring the processor and the memory 402 if necessary. In addition, information required by each processing, for example, the interference elimination information, the cell selection bias value and the like in each embodiment are held in the memory 402.

The network interface (I/F) 404 inputs/outputs a control signal, a transmitted signal before signal processing and a received signal after signal processing. The RF module 405 converts a transmitted signal to a signal in a radio-frequency band, transmits it via the antenna, and converts a signal received via the antenna to a signal in a base band.

Each module and the bus shown in FIG. 8 are not necessarily required to be single. For example, plural CPU/DSP modules 401 may also be provided and plural buses 406 may also be provided. In addition, when the plural buses 406 are provided, all buses are not necessarily required to be connected to all modules and for example, in addition to a bus connected to all the modules, a bus connected to only the memory 402 and the logic circuit 403 may also be provided.

In addition, for example, if the CPU/DSP module 401 configuring the processor can execute operation for signal processing and the control of signal processing in all functions, the logic circuit module 403 may also be omitted. Conversely, if the logic circuit module 403 can execute operation for signal processing and the control of signal processing in all functions, the CPU/DSP module 401 may also be omitted.

The present invention is not limited to the abovementioned embodiments and various variations are included. For example, the abovementioned embodiments are detailedly described to understand the present invention better and the present invention is not necessarily provided with all the described configurations. In addition, a part of the configuration in the certain embodiment can be replaced with the configuration in another embodiment and the configuration in the other embodiment can be added to the configuration in the certain embodiment. Further, the other configuration can be added, deleted or replaced to/with a part of the configuration in each embodiment.

What is claimed is:

1. A radio communication system in which a terminal and a base station communicate by radio,
wherein the base station is provided with a plurality of antennas; and
the base station measures processing gain using the plurality of antennas and adjusts a range in which the terminal is connected to a corresponding base station according to the processing gain.

2. The radio communication system according to claim 1, wherein the larger processing gain of an uplink signal of the processing gain is, the narrower the range in which the terminal is connected is made.

3. The radio communication system according to claim 1, wherein the larger processing gain of a downlink signal of the processing gain is, the wider the range in which the terminal is connected is made.

4. The radio communication system according to claim 1, wherein the range in which the terminal is connected is adjusted by adjusting a cell individual offset value to be reported in the communication range of the radio communication system.

5. The radio communication system according to claim 1, further comprising a center,
wherein the center controls the range in which the terminal is connected to a corresponding base station according to the processing gain of the base station provided with the plurality of antennas.

6. A base station of a radio communication system, comprising:
a plurality of antennas;
a communication unit that communicates with a user terminal by radio; and
a processor that measures processing gain using the plurality of antennas and adjusts a range in which the user terminal is connected to a corresponding base station according to the processing gain.

7. The base station according to claim 6, wherein the processor narrows the range in which the user terminal is connected as processing gain of an uplink signal of the processing gain grows larger.

8. The base station according to claim 6, wherein the processor widens the range in which the user terminal is connected as processing gain of a downlink signal of the processing gain grows larger.

9. The base station according to claim 6, wherein the processor calculates a cell individual offset value to be reported in a communication range of the base station using a cell selection bias value determined based upon the processing gain.

10. The base station according to claim 9, wherein the processor adjusts the range in which the user terminal is connected by adjusting the cell individual offset value.

11. A cell selection control method of a base station,
wherein the base station is provided with a plurality of antennas;
the base station measures processing gain using the plurality of antennas; and
the base station adjusts a range in which a terminal is connected to a corresponding base station according to the measured processing gain.

12. The cell selection control method according to claim 11, wherein the base station performs such control that the range in which the terminal is connected is narrowed as processing gain of an uplink signal of the processing gain grows larger.

13. The cell selection control method according to claim 11, wherein the base station performs such control that the range in which the terminal is connected is widened as processing gain of a downlink signal of the processing gain grows larger.

14. The cell selection control method according to claim 11, wherein the base station calculates a cell individual offset value to be reported in a communication range of the base station using a cell selection bias value determined based upon the processing gain.

15. The cell selection control method according to claim 11, wherein the base station corrects a judgment condition to facilitate handover to a base station having a large cell selection bias value determined based upon the processing gain in determining handover.
